(19) United States
(12) Patent Application Publication
(10) Pub. No.: US 2012/0092706 A1
(43) Pub. Date: Apr. 19, 2012

(54) PRINT SETTING APPARATUS, IMAGE FORMING APPARATUS, AND PRINT SETTING METHOD

(75) Inventor: Seiji Saito, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/225,726

(22) Filed: Sep. 6, 2011

Related U.S. Application Data
(60) Provisional application No. 61/392,680, filed on Oct. 13, 2010.
(60) Provisional application No. 61/392,703, filed on Oct. 13, 2010.
(60) Provisional application No. 61/466,656, filed on Mar. 23, 2011.

(51) Int. Cl. G06F 3/12

(52) U.S. Cl. 358/1.15

(57) ABSTRACT

According to one embodiment, a print setting apparatus includes: an input section; a display section configured to display one or plural sheet images obtained by rendering one sheet and display a list of printing target page images; and a control section configured to render, when at least one page image is selected by the input section and moved to the sheet images, if no existing page image is present in the sheet images, the selected page image on the sheet images and render, if a page image is already rendered on the sheet image, plural page images including the existing page image and the moved page image on the one sheet image.

### CROSS-REFERENCE TO RELATED APPLICATIONS

This application is based upon and claims the benefit of priority from: U.S. provisional application 61/392703, filed on Oct. 13, 2010; U.S. provisional application 61/392680, filed on Oct. 13, 2010; and US provisional application 61/466656, filed on Mar. 23, 2011; the entire contents all of which are incorporated herein by reference.

### FILED

Embodiments described herein relate generally to a setting technique for an image forming apparatus carried out when printing is performed.

### BACKGROUND

When printing is performed, a method of reducing printing target pages and forming images of plural pages (N pages) on one sheet (hereinafter referred to as N in 1) is routinely performed. In performing setting of N in 1, on a setting screen provided by a printer driver or a setting screen displayed by a control panel of an image forming apparatus in the past, a user transitions a screen to a relevant hierarchy, presses a button for enabling the setting of N in 1, and performs setting concerning images for how many pages are formed on one sheet.

However, the user needs to press buttons plural times until the user performs the setting of N in 1. Further, the user needs to memorize to which hierarchy in the setting screen the setting of N in 1 belongs. If the user does not memorize this, in performing these kinds of setting, the user searches for the relevant setting screen.

When the setting screen in the past is used, the user performs the setting by operating the buttons. However, it is difficult for a user who does not routinely perform the setting operation to understand the button operation.

### DESCRIPTION OF THE DRAWINGS

FIG. 1 is a diagram of a configuration example of an image forming apparatus according to a first embodiment;

FIG. 2 is a block diagram of the image forming apparatus;

FIG. 3 is a flowchart for explaining an operation example of the image forming apparatus;

FIG. 4 is a diagram of a display example in an interface section in the first embodiment;

FIG. 5 is a flowchart for explaining an operation example in the first embodiment;

FIGS. 6A and 6B are diagrams for explaining an example of setting operation in the first embodiment;

FIG. 7 is a diagram of a configuration example in which a PC and a tablet PC are applied as print setting apparatuses;

FIG. 8 is a flowchart for explaining an operation example in a second embodiment;

FIGS. 9A and 9B are diagrams for explaining a display example in an interface section in the second embodiment and an example of setting operation for sheet selection;

FIGS. 10A and 10B are diagrams for explaining an example of operation for setting N in 1 for a selected sheet in the second embodiment;

FIG. 11 is a diagram for explaining a display example in an interface section in a third embodiment;

FIG. 12 is a flowchart for explaining an operation example in the third embodiment;

FIGS. 13A and 133 are diagrams for explaining an example of operation for replacing an object image in the third embodiment;

FIGS. 14A and 14B are diagrams for explaining an example of operation for moving an object image in the third embodiment;

FIG. 15 is a diagram for explaining an example of a region in which an object image can be arranged in the third embodiment; and

FIGS. 16A and 16B are diagrams for explaining an example of operation for deleting an object image in the third embodiment.

### DETAILED DESCRIPTION

In general, according to one embodiment, a print setting apparatus includes: an input section; a display section configured to display one or plural sheet images obtained by rendering one sheet and display a list of printing target page images; and a control section configured to render, when at least one page image is selected by the input section and moves to the sheet images, if no existing page image is present in the sheet images, the selected page image on the sheet images and render, if a page image is already rendered on the sheet image, plural page images including the existing page image and the moved page image on the one sheet image.

User interfaces explained in embodiments below allow a user to perform page arrangement setting intuitively and plainly with a small number of times of operation.

A first embodiment provides a user interface that can set N in 1 intuitively and plainly with a small number of times of operation by dropping a printing target image on a preview image.

A second embodiment provides a user interface that designates, in a rectangular area, an image desired to be printed to select the image and drops the image on a preview image to reflect it in N in 1 setting according to the number of images.

A third embodiment provides an object arrangement setting environment of a high degree of freedom that can changes the positions of objects and move the objects to a free space by moving a printing target image in a preview area.

### First Embodiment

The first embodiment is explained below with reference to the accompanying drawings.

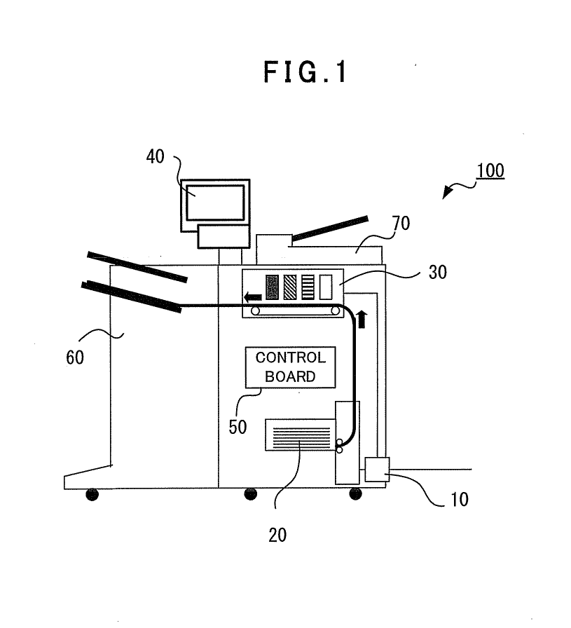

An example of a hardware configuration of an image forming apparatus according to the first embodiment is shown in FIG. 1. An image forming apparatus 100 includes an external information input section 10, a sheet storing section 20, a printing section 30, an interface section 40, a control board 50, a finishing apparatus 60, and a reading section 70.

The external information input section 10 is a unit configured to receive printing data created by an external apparatus such as a personal computer (hereinafter referred to as PC) and includes a network interface card. The sheet storing section 20 is a unit configured to store sheets and convey the stored sheets to a main body section of the image forming apparatus 100 and includes a pickup roller and a tray.

The printing section 30 is a unit configured to form images of colors of C (cyan), M (magenta), Y (yellow), and K (black) on a sheet conveyed from the sheet storing section 20. The printing section 30 forms images of printing target data input from the external information input section 10 and image data of an original document read by the reading section 70 on the sheet. The printing section 30 includes, for each of the colors, a process unit including a photoconductive drum and a charging roller.

The interface section 40 is a control panel configured to display a state of the image forming apparatus 100 and a progressing situation of a job to a user and acquire an instruction and setting from the user. In the interface section 40, a liquid crystal panel is used as a display, and an input device of a touch panel type mounted with a touch sensor is used as an input section.

The control board 50 is a board configured to collectively control respective kinds of hardware in the image forming apparatus 100. The finishing apparatus 60 is an apparatus configured to execute, on the basis of setting by the user, processing for stapling a bundle of sheets on which images are formed (stapling) and processing for punching plural sheets in the same positions (hole punching). The finishing apparatus 60 includes at least a stapling device and a puncher device.

The reading section 70 is a unit configured to scan an image drawn on a sheet arranged on a transparent tray and convert the image into image data. The reading section 70 includes at least the transparent tray on which a printing target sheet is placed, a light emitting device, and a CCD image sensor (Charge Coupled Device Image Sensor). As shown in FIG. 1, the reading section 70 may include an auto document feeder.

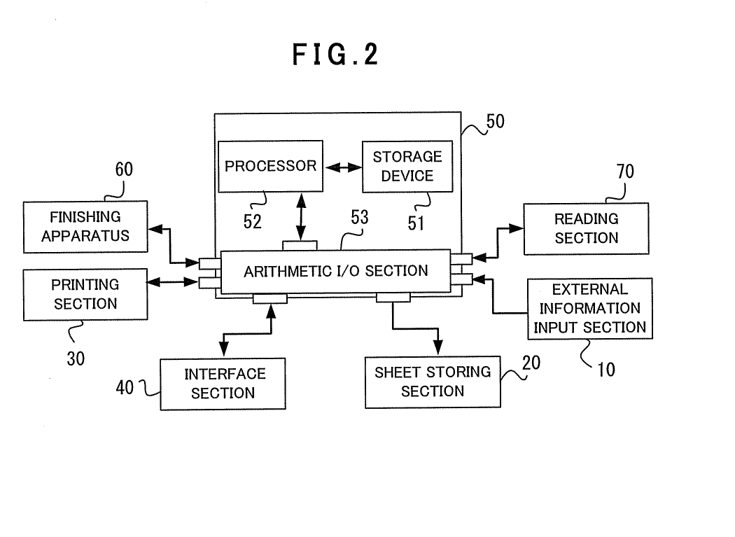

The configuration of the control board 50 is explained with reference to FIG. 2. The control board 50 includes a storage device 51, a processor 52, and an arithmetic I/O section 53. The storage device 51 is a device configured to store various data and programs. The storage device 51 includes, for example, a RAM (Random Access Memory), a ROM (Read Only Memory), a DRAM (Dynamic Random Access Memory), an SRAM (Static Random Access Memory), a VRAM (Video RAM), or a hard disk drive. The processor 52 is an arithmetic processing device configured to execute an arithmetic operation of the computer programs stored in the storage device 51 to control the respective kinds of hardware in the image forming apparatus 100. The processor 52 is, for example, a CPU (Central Processing Unit) or an MPU (Micro Processing Unit)

The arithmetic I/O section 53 is a data bus configured to control data communication among the respective kinds of hardware in the image forming apparatus 100. A control signal and data from the processor 52 are transmitted to the respective kinds of hardware through the arithmetic I/O section 53.

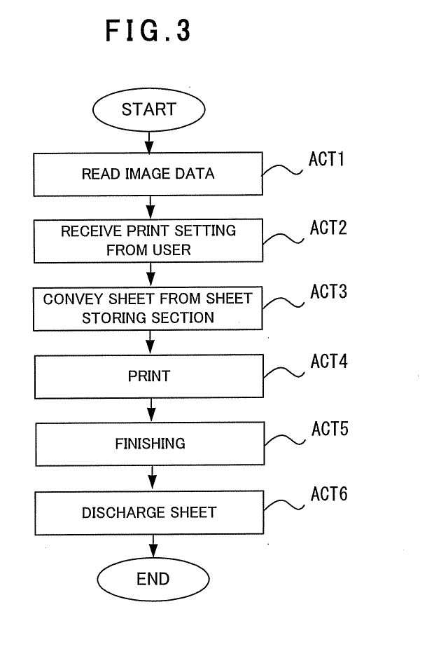

FIG. 3 is a flowchart for explaining an operation example of the image forming apparatus 100. The external information input section 10 acquires print job information including printing target image data from the external apparatus. The acquired image data is stored in the storage device 51 through the arithmetic I/O section 53 according to the control by the processor 52 (ACT 1). The image data may be data scanned from a sheet by the reading section 70.

The interface section 40 receives information concerning print setting (the number of prints, selection of monochrome or color, designation of stapling or hole punching, setting of N in 1, and the like) from the user (ACT 2). An example of the operation in ACT 2 is explained in detail later.

After the information concerning the print setting from the user is acquired, the sheet storing section 20 conveys a stored sheet to the main body section (ACT 3). The printing section 30 forms an image of the image data read in ACT 1 on the conveyed sheet (ACT 4). The printing section 30 forms an image in an N in 1 format, for example, on the basis of the print job information.

If there is a setting of stapling or hole punching concerning the print job, the finishing apparatus 60 applies finishing such as stapling or hole punching to a printed sheet bundle (ACT 5). Thereafter, the sheet is discharged (ACT 6).

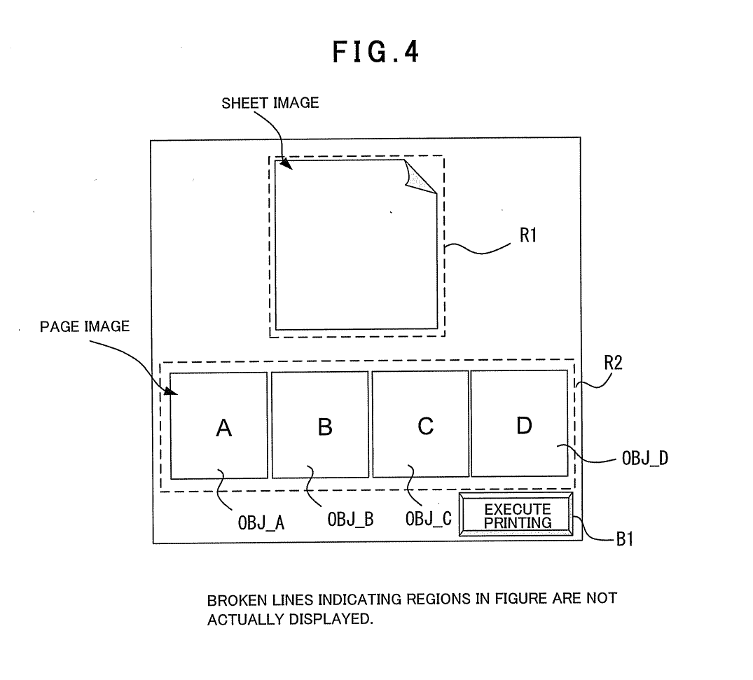

An operation in performing setting of N in 1 in ACT 2 is explained. FIG. 4 is an example of a setting screen for N in 1 displayed by the interface section 40. As shown in FIG. 4, the interface section 40 includes a print preview region R1 (hereinafter referred to as region R1) and a read image display region R2 (hereinafter referred to as region R2)

In the region R1, a preview image showing a state of a sheet after printing is displayed. In the example shown in FIG. 4, an image imitating the sheet (hereinafter referred to as sheet image) is displayed in the region R1. However, two or more sheet images may be displayed.

In the region R2, thumbnail images obtained by reducing the images acquired in ACT 1 (hereinafter referred to as page images) are displayed as a list. In the example shown in FIG. 4, four images are acquired in ACT 1. The interface section 40 displays, in the region R2, page images OBJ_A to OBJ_D obtained by reducing these images. An arbitrary page image among the page images displayed in the region R2 is touched (this operation by the user is hereinafter referred to as “selection” when necessary). When the page image is carried to the region R1 and a fingertip is released from a touch panel (this operation by the user is hereinafter referred to as “release”), the selected page image is drawn on the sheet image in the region R1.

Plural sheet images are displayed in the region R1. For example, when two sheet images are present, concerning the next sheet image, similarly, a page image in the region R2 is selected and released on the sheet image in the region R1, whereby the selected page image is drawn on the sheet image. Such display control is performed by the processor 52. According to this display control, the user can intuitively perform arrangement and setting of the page images and N in 1 setting.

If a print execution button B1 is pressed, the respective kinds of setting are decided. The processor 52 writes information concerning a page layout in the print job information according to the layout of the page images arranged on the sheet image. The printing section 30 executes printing on the basis of the image data and the setting information included in the decided print job information.

An image for display and coordinate information of a display position shown in FIG. 4 are stored in the storage device 51. The display on the interface section 40 is controlled by the processor 52 executing arithmetic operations of a predetermined rendering program and a predetermined display control program.

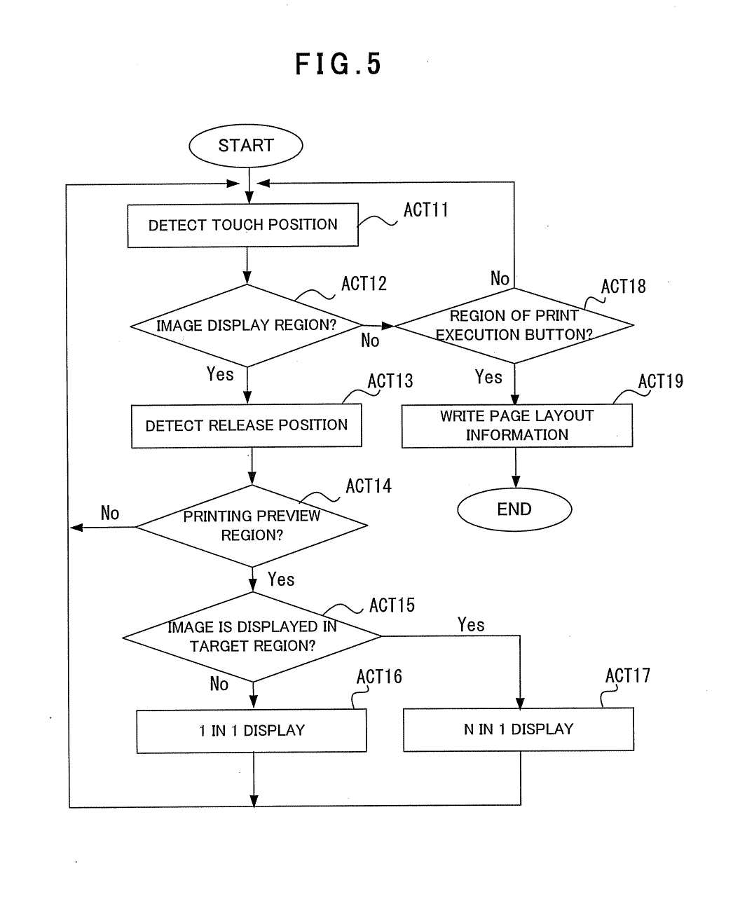

A setting operation concerning N in 1 of the image forming apparatus 100 is explained with reference to a flowchart of FIG. 5.

The processor 52 detects a position sensed by the touch sensor of the interface section 40 (a position on the display screen touched by the user) (ACT 11). The detection is performed by the processor 52 acquiring, from the interface section 40, coordinate information of a position touched by the user.

The processor 52 determines whether the coordinate of the touched position is within the region R2 (ACT 12). If it is within the region R2 (Yes in ACT 12), the processor 52 controls display such that a selected page image in the region R2 (in this example, any one of the page images OBJ_A to OBJ_D) moves in association with the movement of the fingertip.

Subsequently, the processor 52 detects a release position of the selected page image (ACT 13). This detection is performed by the processor 52 acquiring, from the interface section 40, coordinate information of a position where the fingertip of the user is released from the touch panel (a release position). The processor 52 determines whether the release position is within the region R1 (ACT 14). If the release position is within the region R1 (Yes in ACT 14), the processor 51 determines whether the page image is already arranged in the sheet image displayed in the region R1 (ACT 15). In ACT 15, the processor 52 determines whether a value of a cumulative number of images at the present point of the sheet image is equal to or larger than 1. The cumulative number of images is data obtained by counting the number of page images arranged in the sheet image.. Besides this implementation, flag data for each sheet image (data having a different value depending on whether a page image is already present or absent) may be used.

If no existing page image is found on the released sheet image (No in ACT 15), the processor 52 controls the display such that the sheet image in the region R1 is formed in a 1 in 1 format (ACT 16). On the other hand, if a page image is already present on the released sheet image (Yes in ACT 15), the processor 52 controls display such that the sheet image within the region R1 is formed in an N in 1 format (ACT 17). Here, N is a number obtained by adding 1 to the number of images already displayed on the sheet image. Thereafter, the processor 52 adds 1 to the cumulative number of images of the page and causes the storage device 51 to store the cumulative number of images.

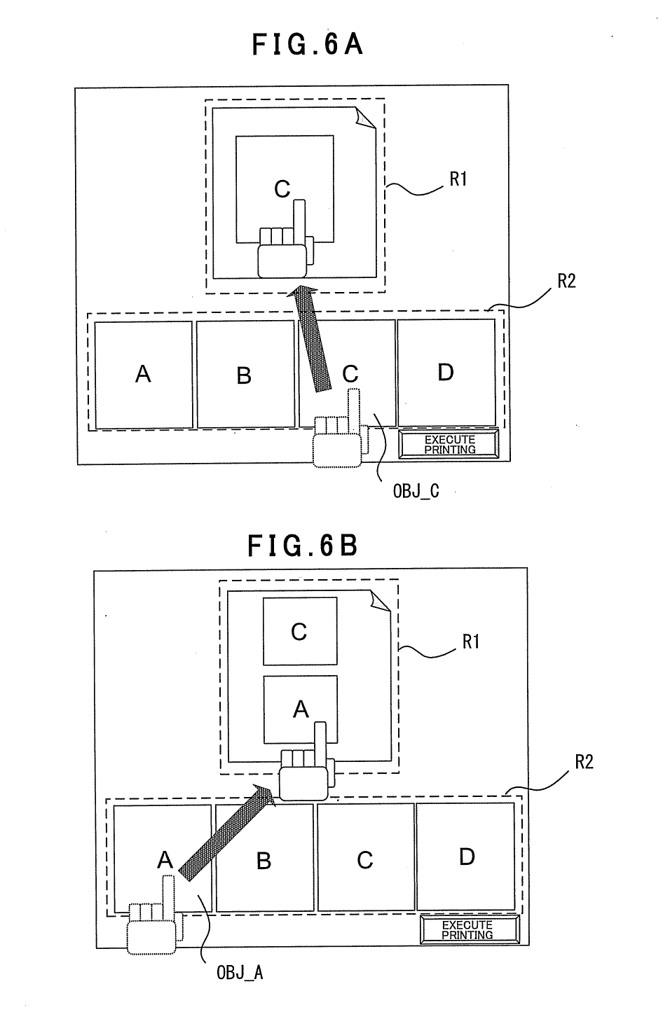

An example of 1 in 1 display is shown in FIG. 6A. An example of 2 in 1 display is shown in FIG. 6B. In FIG. 6A, since there is no image already released at the present point, the cumulative number of images is 1, i.e., one page image is released now and the 1 in 1 display is performed. If a page image is further released from the state shown in FIG. 6A, the 2 in 1 display is performed as shown in FIG. 6B. In the example shown in FIG. 6B, since OBJ_C is already released and, in addition, OBJ_A is released, the cumulative number of images becomes 2. When the processor 52 performs rendering of N in 1, the processor 52 reduces a page image already arranged on a sheet image and a page image to be arranged anew at the same ratio such that the page images fit within one sheet image and renders the page images on the sheet image. In other words, in the case of a layout of 2 in 1, page images for two sheets having the same size are rendered on the sheet image and a sheet image shown in FIG. 6B is displayed in the region R1.

If it is decided in the determination in ACT 12 that a region other than the region R2 is touched (No in ACT 12), the processor 52 determines whether a display region of the print execution button B1 is selected (ACT 18). Here, if the region of the print execution button B1 is selected (Yes in ACT 18), the processor 52 decides setting information of N in 1, i.e., page layout information concerning which image is rendered on which sheet and writes the decided page layout information in the print job information (ACT 19). The setting processing ends and, thereafter, the processing in ACT 3 shown in FIG. 3 is performed. On the other hand, if the touch position is not in the region of the print execution button B1 (No in ACT 18), the processing returns to ACT 11.

If the release position is not within the region R1 (No in ACT 14) and the processing in ACTS 16 and 17 ends, the processing returns to ACT 11.

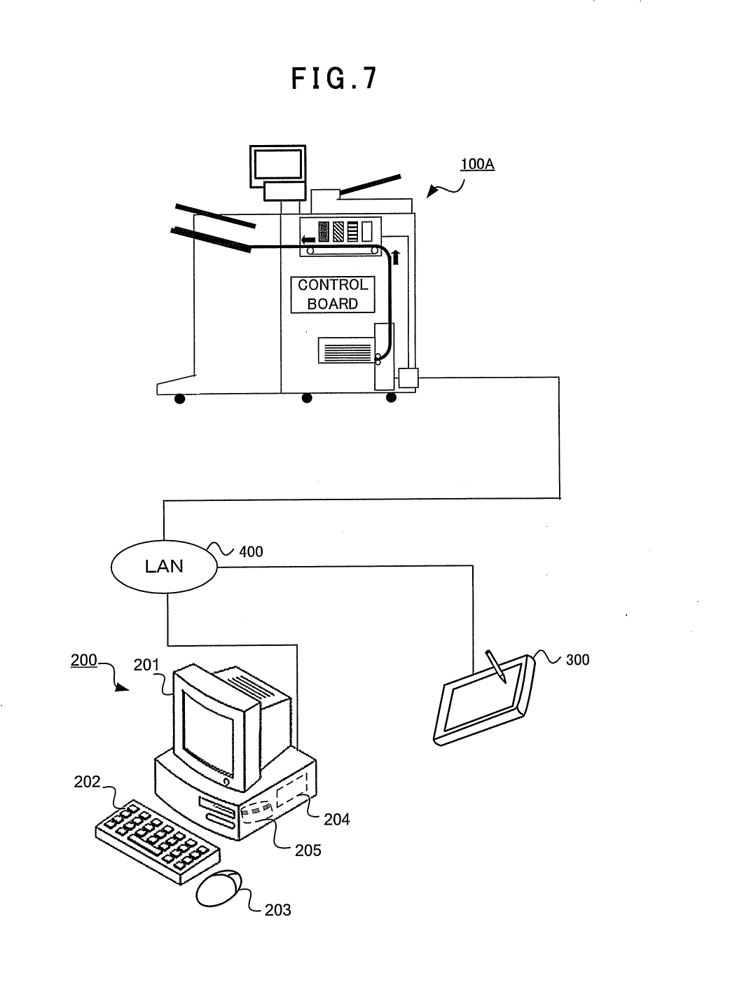

In the above explanation, the configuration including the interface section 40 and the control board 50 of the image forming apparatus 100 is explained as the print setting apparatus. However, as shown in FIG. 7, a PC 200 connected to an image forming apparatus 100A in the past via a LAN (Local Area Network) 400 can also be applied as the print setting apparatus. In other words, the same operations as explained above can be realized by using a CPU 204, a memory 205, a monitor 201, which is a display section, and a keyboard 202 or a mouse 203, which is an input section, of the PC 200. The print setting apparatus can be naturally applied to a tablet PC 300 including a CPU, a memory, and a display of a touch panel type. If the first embodiment is employed, although a user interface is different from that in the past, a telegraphic message format same as that in the past can be applied to a data structure of setting information, print job information, and the like. Therefore, even if the PC 200 or the tablet PC 300 is used as a client apparatus for print setting (the print setting apparatus), since the print job information and the setting information to be transmitted are in the format in the past, the image forming apparatus 100A in the past can be directly applied. The LAN 400 may be either a wired or wireless LAN.

### Second Embodiment

In the first embodiment, the implementation example for selecting the page images in the region R2 one by one and releasing the page images on the sheet image one by one is explained. In the second embodiment, an implementation example for collectively selecting plural page images and releasing the page images on a sheet image is explained. Components and operations other than those explained below are the same as those in the first embodiment. Therefore, explanation of the similar components and operations is omitted (see FIGS. 1 to 3 and 7)

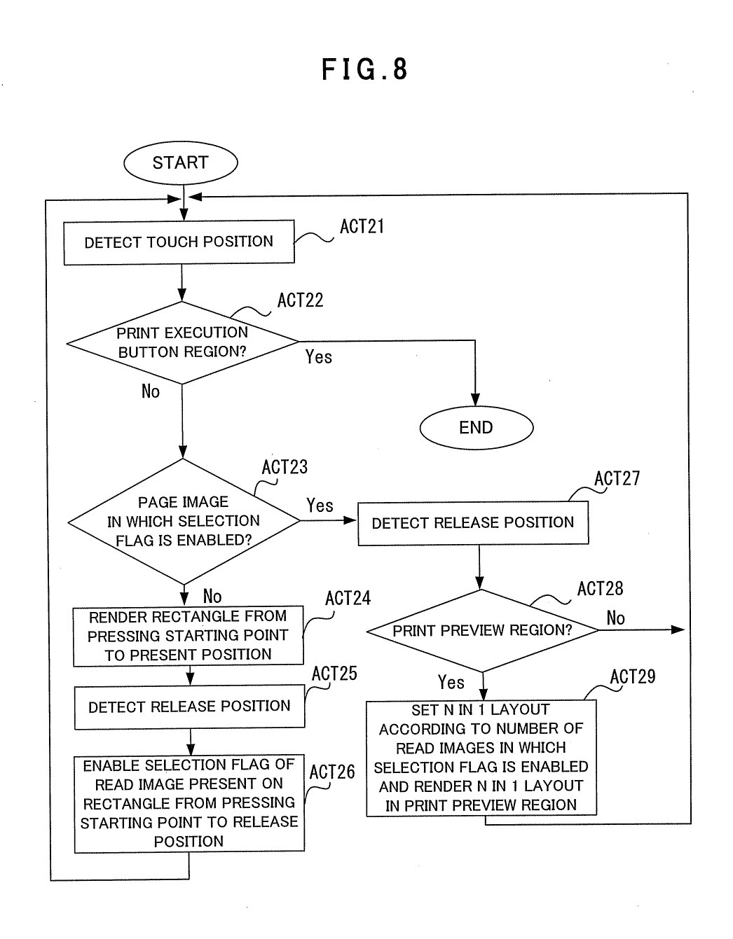

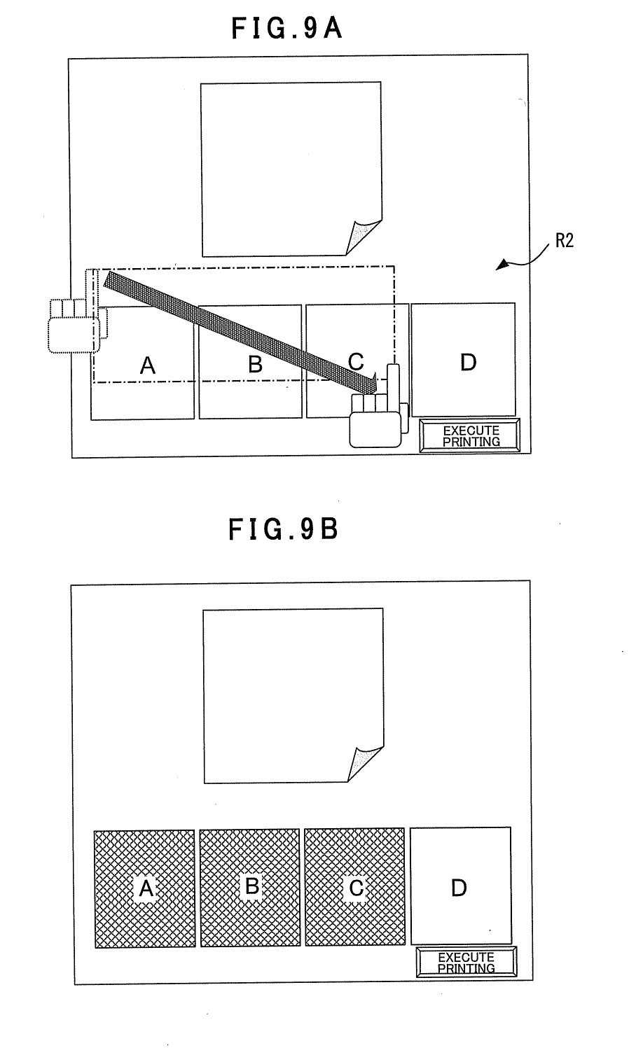

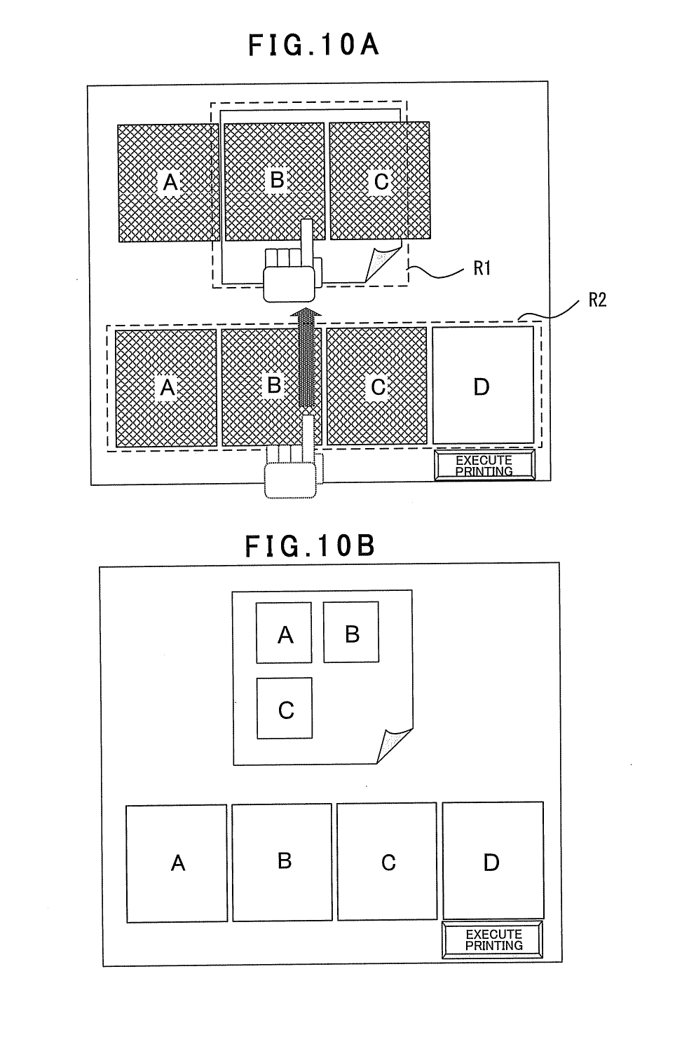

An operation example of the second embodiment is shown in FIG. 8. A screen transition example is shown in FIGS. 9A to 10B. The print preview region R1, the read image display region R2, the page images OBJ_A to OBJ_D, and the print execution button B1 are the same as those in the first embodiment.

An operation in the second embodiment is explained with reference to FIG. 8. The processor 52 detects a touch position of a user in the same manner as in the first embodiment (ACT 21). The processor 52 determines whether a touched region is the region of the print execution button 31 (ACT 22). If the touched region is the region of the print execution button B1 (Yes in ACT 22), the print setting processing ends and the processing in ACT 3 onward shown in FIG. 3 is executed.

Subsequently, the processor 52 determines whether the touched position is a page image in the region R2 and is a page image in which a selection flag (flag data prepared for each page image) is enabled (ACT 23). If the touched position is not the relevant image (No in ACT 23), the processor 52 renders a rectangle from the starting point of the touch position to the present fingertip position as shown in FIG. 9A (ACT 24). The processor 52 detects a position where a fingertip is released (ACT 25). As shown in FIG. 9B, the processor 52 enables the selection flag of the page image included in the rectangle region from the starting point of the touch position to the position where the fingertip is released (ACT 26). The processor 52 acquires, from the interface section 40, coordinate information of the touch position and the position where the fingertip is released and sets a region formed by the two kinds of coordinate information as the region of a selected range. As shown in FIG. 9B, the processor 52 controls to make the display of a page image in which the selection flag is enabled different from the display of a page image in which the selection flag is disabled, by displaying the image in which the selection flag is enabled as a halftone dot meshing image, for example.

After the processing in ACT 26 is performed, the processing returns to ACT 21 and the processings in ACTS 21, 22, and 23 are subsequently performed.

If it is decided in ACT 23 that a page image in which the selection flag is enabled is touched (Yes in ACT 23), thereafter, the processor 52 detects a release position (ACT 27) and determines whether the release position is within the region R1 (ACT 28). An operation example by the user from ACT 23 to ACT 28 is shown in FIG. 10A. The processor 52 controls such that selected plural page images move in association with the movement of the fingertip.

In a state in which the page images move in association with the movement of the fingertip, if the release position is within the region R1 (Yes in ACT 28), the processor 52 sets information concerning N in 1 according to the number of released images and renders released page images on a sheet image (ACT 29). A state after the processing in ACT 29 is shown in FIG. 10B. The processor 52 renders released plural page images on one sheet image.

Thereafter, the processing returns to ACT 21. If the print execution button 31 is touched in ACT 22 (Yes in ACT 22), the decided information concerning N in 1 is written in the print job information and printing is executed. The printing section 30 forms images on the sheet according to setting values in the print job information.

### Third Embodiment

If the arrangement of images, such as an insertion of images or order of images, is changed in the same sheet or among sheets, in the past, a method of pressing a setting button and adjusting the arrangement of images is known. In the method in the past, the arrangement cannot be freely changed because there are specific limitations, for example, the arrangement can be changed only in a range in which the order is observed. In the third embodiment, a user interface with which the user can intuitively operate a change of the arrangement of images and deletion of images is explained. The following explanation can be applied not only to N in 1 but also to 1 in 1.

In the third embodiment, as in the second embodiment, components and operations other than those explained below are the same as those in the first embodiment. Therefore, explanation of the similar components and operations is omitted (see FIGS. 1 to 3 and 7)

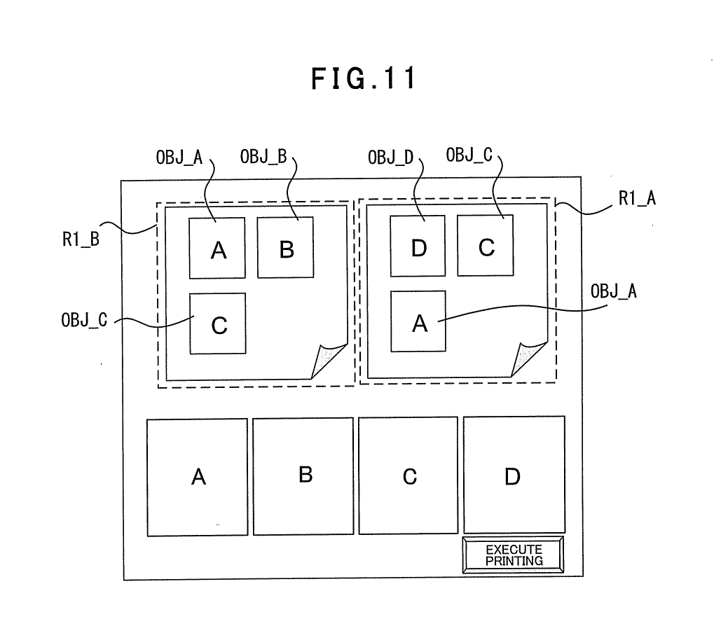

First, an example of a display screen displayed on the interface section 40 (an example of an initial state) is shown in FIG. 11. In the following explanation, an example in which there are two regions equivalent to the print preview region R1 in the first embodiment as shown in FIG. 11 is explained. These regions are a region R1_A and a region R1_B. One sheet image is arranged in each of the region R1_A and the region R1_B. As shown in FIG. 11, in the initial state, page images OBJ_D, OBJ_C, and OBJ_A (in the third embodiment, the page images are referred to as object images) are already arranged in the region R1_A and object images OBJ_A, OBJ_B, and OBJ_C are already arranged in the region R1_B.

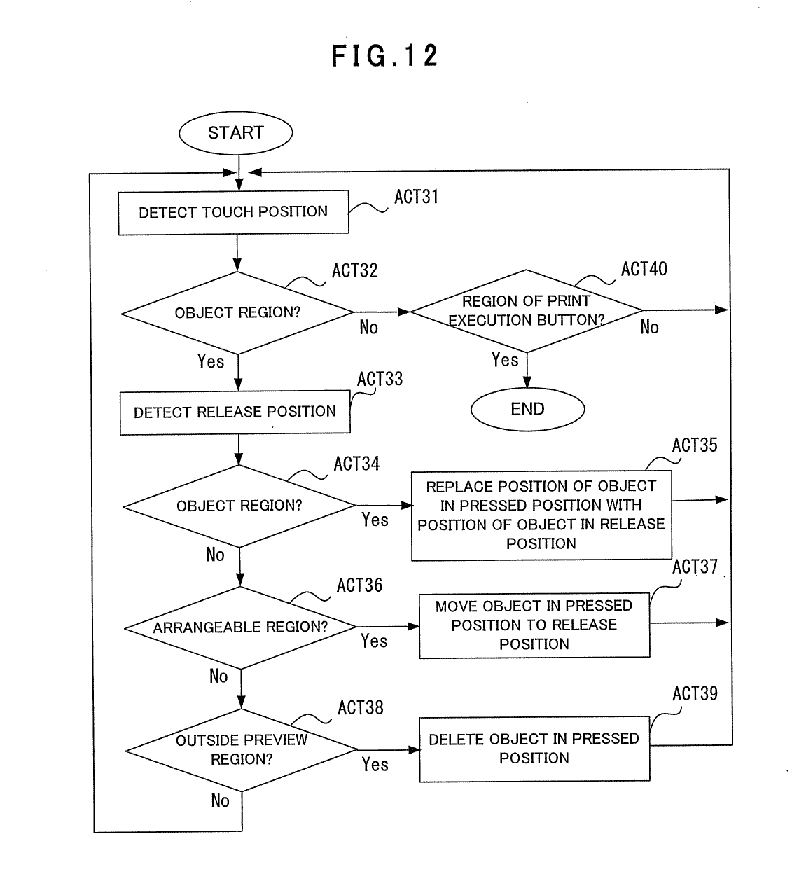

The third embodiment is explained with reference to a flowchart of FIG. 12.

The processor 52 detects a touch position of a user in the same manner as in the first embodiment (ACT 31). The processor 52 determines whether the detected position is within a region of an object image arranged in any one of the region R1_A and the region R1_B (ACT 32). If the detected position is within the region of the object image (Yes in ACT 32), the processor 52 controls the display such that the object image moves in association with the movement of a fingertip.

Subsequently, the processor 52 detects a release position (ACT 33). The processor 52 determines whether the release position is a region of another object image arranged in the region R1_A and the region R1_B (ACT 34). If the release position is a region of another object image (Yes in ACT 34), the processor 52 controls the display to replace the object image touched in ACT 31 with the object image arranged in the release position (Act 35).

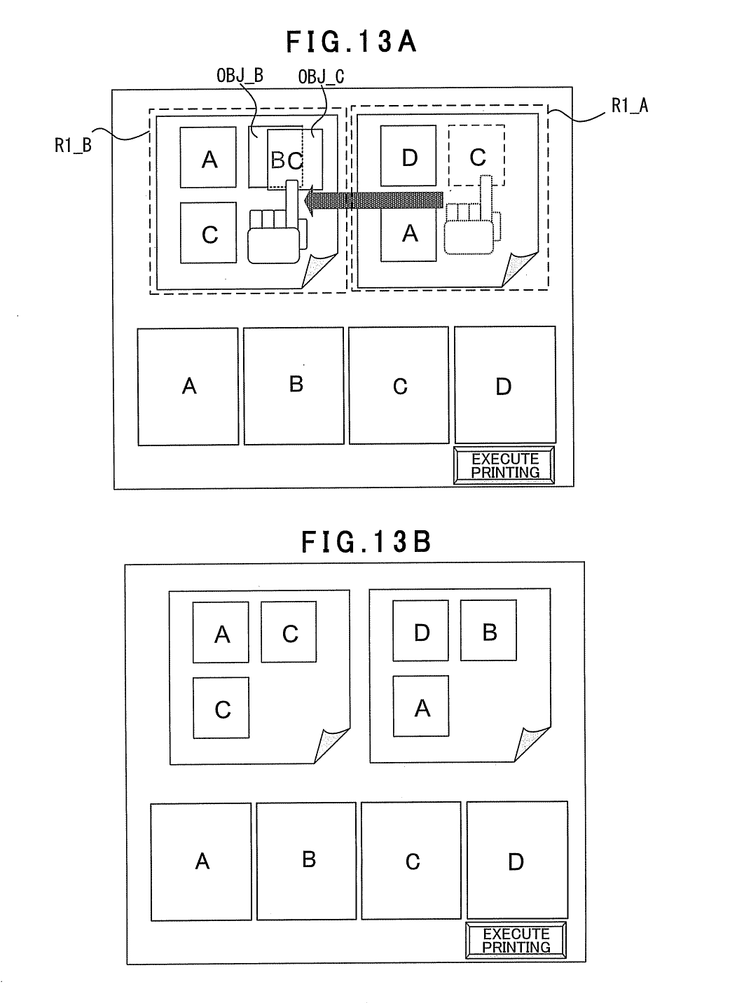

Concerning the transition of the display explained above, an example is shown in FIGS. 13A and 13B. As shown in FIG. 13A, if OBJ_C in the region R1_A is selected and moved onto OBJ_B in the region R1_B, OBJ_B is replaced with OBJ_C as shown in FIG. 13B. This operation can also be performed in the same sheet. For example, it is also possible to replace OBJ_A in the region R1_A with OBJ_D in the region R1_A.

Referring back to the flowchart of FIG. 12, if it is determined in ACT 34 that the release position is not in a region of another object image (No in ACT 34), the processor 52 determines whether the release position is in an arrangeable region in the region R1_A and the region R1_B (ACT 36). The arrangeable region is a margin region where an object image can be arranged.

If the release position is in the arrangeable region (Yes in ACT 36), the processor 52 controls the display such that the object image touched in Act 31 moves to the arrangeable region (ACT 37). In other words, the processor 52 controls the display to render the released object image in the arrangeable region and delete the existing object image touched in ACT 1.

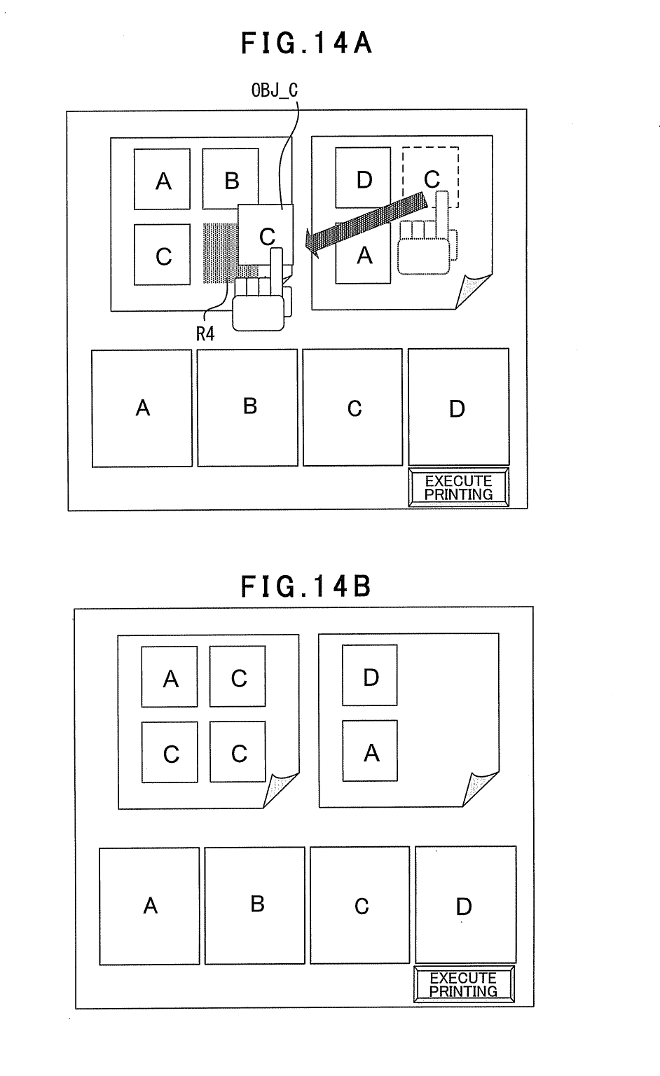

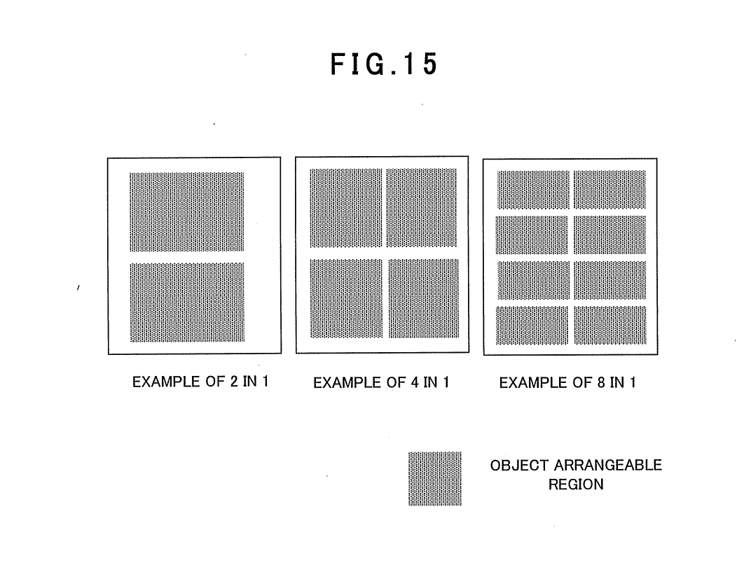

An example of the screen transition in ACTS 36 and 37 is shown in FIGS. 14A and 14B. As shown in FIG. 14A, if OBJ_C in the region R1_A is touched and released in an arrangeable region R4 in the region R1_B, OBJ_C moves to the position of the arrangeable region R4, as shown in FIG. 14B. This operation can also be performed in the same page in the same manner as explained above. An example of arrangeable regions in cases of 2 in 1, 4 in 1, and 8 in 1 is shown in FIG. 15. In the third embodiment, coordinate information of the arrangeable regions is stored in the storage device 51 in advance for the respective cases of 2 in 1, 4 in 1, and the like. The processor 52 acquires the coordinate information of the arrangeable regions from the storage device 51 and performs rendering of object images.

Referring back to the flowchart of FIG. 12, if it is determined in ACT 36 that the release position is not in the arrangeable region (No in ACT 36), the processor 52 determines whether the release position is in a region other than the regions R1_A and the region R1_B (Act 38). If the release position is in a region other than the region R1_A and the region R1_B (Yes in ACT 38), the processor 52 controls the display to delete the image touched in ACT 31 (ACT 39)

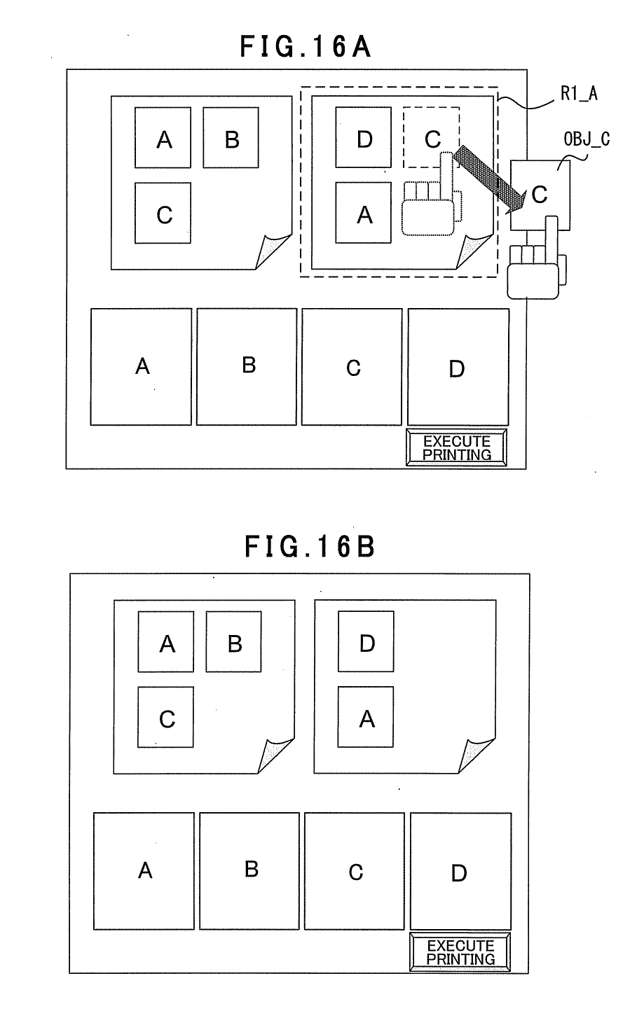

An example of the screen transition in ACTS 38 and 39 is shown in FIGS. 16A and 16B. As shown in FIG. 16A, for example, if OBJ_C in the region R1_A is touched and released in a region other than the region R1_A and the region R1_B, OBJ_C in the region R1_A is deleted, as shown in FIG. 16B.

After the processing in any one of ACT 35, ACT 37 and ACT 39 is performed, the processing returns to ACT 31. Thereafter, if it is determined in ACT 32 that the touch position is not in the object image region (No in ACT 32), the processor 52 determines whether the touch position is the print execution button B1 (ACT 40). If the touch position is the print execution button B1 (Yes in ACT 40), set N in 1 information and arrangement information such as a change and deletion are written in the print job information and printing is executed. The printing section 30 forms an image on a sheet according to setting values in the print job information.

The application of the first to third embodiments makes it easy to perform operation for setting N in 1 and changing image arrangement. This makes it possible to provide a more intuitively plain setting environment than setting in the past such as N in 1 having a hierarchical structure. In a layout of a setting screen in the past, plural tabs for “basic setting”, “finishing”, “image quality”, and the like are arranged above one print setting dialog and a most display region in the dialog is switched by switching the tabs. If the user performs N in 1 and arrangement setting by using the setting screen in the past, the user needs to press the tab for finishing and press a check box for enabling N in 1 provided in the tab. This operation is complicated and the user needs to remember that the setting of N in 1 is present in the finishing tab. In general, in a setting dialog in performing printing, information in the tab for basic setting is initially displayed and setting of stapling is not displayed. Therefore, if a frequency of use is not high, work for searching for a setting screen for N in 1 must be performed every time. The application of the embodiments makes it possible to display a print preview and perform intuitively plain setting work by using the print preview.

As explained above in detail, according to the technique described in this specification, setting operation concerning the arrangement of images on a sheet is facilitated.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. A print setting apparatus comprising:
an input section;
a display section configured to display one or plural sheet images obtained by rendering one sheet and display a list of printing target page images; and
a control section configured to render, when at least one page image to be displayed by the display section is selected by the input section and moved to the sheet images, if no existing page image is present in the sheet images, the selected page image on the sheet images and render, if a page image is already rendered on the sheet images, plural page images including the existing page image and the moved page image on the one sheet image.

2. The apparatus according to claim 1, wherein the control section reduces the existing page image and a page image to be arranged anew at a same ratio such that the page images fit within the one sheet image and renders the page images on the sheet image.

3. The apparatus according to claim 1, wherein, if plural page images are collectively selected from the list and moved onto the one sheet image, the control section renders the selected plural page images on the one sheet image.

4. The apparatus according to claim 3, wherein the control section acquires plural kinds of coordinate information designated by a user from the input section and renders, on the one sheet image, plural page images included in a region formed by the plural kinds of coordinate information.

5. The apparatus according to claim 1, wherein, if one of plural page images rendered on one or plural sheet images is selected by the input section and the page image is moved onto another page image on the sheet images, the control section replaces the other page image with the moved page image and renders the moved page image.

6. The apparatus according to claim 1, wherein, if a page image rendered on one or plural sheet images is selected by the input section and the page image is moved to another margin region on the sheet images, the control section deletes the selected page image and renders the selected page image in the margin region.

7. The apparatus according to claim 1, wherein, if a page image rendered on one or plural sheet images is selected by the input section and moved to a region other than a region of the sheet images, the control section deletes the selected page image from the sheet images.

8. The apparatus according to claim 1, wherein the control section further writes, in print job information, layout information that coincides with the layout of page images arranged on the sheet images.

9. The apparatus according to claim 1, wherein the input section is an input device of a touch panel type.

10. An image forming apparatus comprising:
an image acquiring section configured to acquire a printing target page image;
an input section;
a display section configured to display one or plural sheet images obtained by rendering one sheet and display a list of printing target page images acquired by the image acquiring section;
a control section configured to render, when at least one page image to be displayed by the display section is selected by the input section and moved to the sheet images, if no existing page image is present in the sheet images, the selected page image on the sheet images and render, if a page image is already rendered on the sheet images, plural page images including the existing page image and the moved page image on the one sheet image; and
a printing section configured to form page images acquired by the image acquiring section on the sheet such that the page images coincide with the layout rendered on the sheet images by the control section.

11. The apparatus according to claim 10, wherein the control section reduces the existing page image and a page image to be arranged anew at a same ratio such that the page images fit within the one sheet image and renders the page images on the sheet image.

12. The apparatus according to claim 10, wherein, if plural page images are collectively selected from the list and moved onto the one sheet image, the control section renders the selected plural page images on the one sheet image.

13. The apparatus according to claim 12, wherein the control section acquires plural kinds of coordinate information designated by a user from the input section and renders, on the one sheet image, plural page images included in a region formed by the plural kinds of coordinate information.

14. The apparatus according to claim 10, wherein, if one of the plural page images rendered on one or plural sheet images is selected by the input section and moved onto another page image on the sheet images, the control section replaces the other page image with the moved page image and renders the moved page image.

15. The apparatus according to claim 10, wherein, if a page image rendered on one or plural sheet images is selected by the input section and moved to another margin region on the sheet images, the control section deletes the selected page image and renders the selected page image in the margin region.

16. The apparatus according to claim 10, wherein, if a page image rendered on one or plural sheet images is selected by the input section and moved to a region other than a region of the sheet images, the control section deletes the selected page image from the sheet images.

17. A print setting method for a print setting apparatus comprising:
displaying one or plural sheet images obtained by rendering one sheet and displaying a list of printing target page images; and
rendering, when at least one page image is selected and moved to the sheet images, if no existing page image is present in the sheet images, the selected page image on the sheet images and rendering, if a page image is already rendered on the sheet images, plural page images including the existing page image and the moved page image on the one sheet image.

18. The method according to claim 17, further comprising reducing the existing page image and a page image to be arranged anew at a same ratio such that the page images fit within the one sheet image and rendering the page images on the sheet image.

19. The method according to claim 17, further comprising rendering, if plural page images are collectively selected from the list and moved onto the one sheet image, the selected plural page images on the one sheet image.

20. The method according to claim 19, further comprising replacing, if one of the plural page images rendered on one or plural sheet images is selected and moved onto another page image on the sheet images, the other page image with the moved page image and rendering the moved page image.
